(19) United States
(12) Patent Application Publication
(10) Pub. No.: US 2005/0143572 A1
(43) Pub. Date: Jun. 30, 2005

(54) Modified cellulose ethers, obtainable by reaction of cellulose ethers carrying free hydroxy groups with di- and/or polycarboxylic acids and the use of catalysts, and method for producing the same

(76) Inventor: Alf Hammes, Sulzbach (DE)

Correspondence Address: RICHARD S. ROBERTS;ROBERTS & ROBERTS, ATTORNEYS AT LAW, P.O. BOX 484, PRINCETON, NJ, 08542, US

(21) Appl. No.: 10/275,855

(22) PCT Filed: May 11, 2001
(86) PCT No.: PCT/EP01/05374

(30) Foreign Application Priority Data
May 13, 2000 (DE) 100 23 540.9

(51) Int. Cl. C08B 13/00

(52) U.S. Cl. 536/66

(57) ABSTRACT

The invention relates to a method for the production of cellulose ethers, whereby cellulose ethers having free hydroxyl groups are reacted with dicarboxylic and/or polycarboxylic acids and a nitrogen-containing compound. The process further comprises intensively mixing essentially dry, pulverulent cellulose ether with a mixture of organic bifunctional and/or polyfunctional acid and nitrogen-containing compound in a non-nucleophilic organic solvent prior to reacting the cellulose ether to provide the modified cellulose ether which can be stirred into water at a pH greater than or equal to 11 without agglutination.

Modified cellulose ethers which can be obtained by reacting cellulose ethers having free hydroxyl groups with dicarboxylic and/or polycarboxylic acids in the added presence of catalysts, and a process for preparing them

The present invention is described in the German priority application No. 100 23540.9, filed May 13th, 2000, which is hereby incorporated by reference as is fully disclosed herein.

The present application relates to modified cellulose ethers which can be obtained by reacting common cellulose ethers having free hydroxyl groups with at least one organic dicarboxylic and/or polycarboxylic acid while activating the organic acid(s) with carbodiimides or carbonyldiimidazoles, and to a process for preparing them. The resulting, modified cellulose ethers are distinguished by a superior, agglomeration-free ability to be stirred in and a delay in starting to swell when being stirred into aqueous solutions, even at strongly alkaline pH values (pH≧11).

The preparation of cellulose ethers having the same or different substituents has been disclosed (see, for example, Ullmann's Enzyklopädie der Technischen Chemie [Ullmann's Encyclopedia of Industrial Chemistry], vol. 9, “Cellulose ethers”, Verlag Chemie, Weinheim, 4th edition 1975, pp. 192ff; K. Engelskirchen: “Polysaccharid-Derivate [Polysaccharide derivatives]” in Houben Weyl, vol. E20/III, 4th edtn., Georg Thieme Verlag Stuttgart, 1987, pp. 2042ff).

In order to prepare these cellulose ethers, for example methyl cellulose, ethyl cellulose, carboxymethyl cellulose, hydroxyethyl cellulose, hydroxypropyl cellulose, methylhydroxyethyl cellulose, methylhydroxypropyl cellulose and ethylhydroxyethyl cellulose, the starting material, i.e. the cellulose, is first of all ground in order to increase the surface area, with the intention being that the particle size should as a rule be less than 2.5 mm, and if at all possible even less than 1 mm. The resulting, voluminous cellulose powder is converted into “alkali cellulose” by adding base, such as NaOH, KOH, LiOH and/or NH₄OH, in solid or liquid form. This is then followed, with or without the alkali cellulose being isolated, by a single-step or multistep, continuous or discontinuous etherification using the corresponding reagents. The resulting cellulose ethers are freed, in a known manner, from reaction byproducts using water or suitable solvent mixtures and then dried, ground and, where appropriate, mixed with other components.

Despite these cellulose ethers having good solubility in cold water, it is frequently a problem to prepare aqueous solutions of these compounds. This is the case, in particular, when the cellulose ether is present as a fine powder having an increased surface area. When such a cellulose ether powder comes into contact with water, the individual particles swell and agglutinate to form relatively large agglomerates whose surface is thickened in a gel-like manner. However, a certain proportion, which depends on the mixing intensity, of completely unwetted cellulose ether is present in the interior of these agglomerates. Depending on the viscosity of the resulting solution, and the average polymer chain length, it can take up to 24 hours to dissolve these agglomerates completely.

In order to diminish the clumping which occurs when preparing aqueous solutions of cellulose ethers, the cellulose ethers can be treated with surfactants, as described, for example, in U.S. Pat. No. 2,647,064 and U.S. Pat. No. 2,720,464.

In addition to this, it is desirable, for some applications, to have a certain open time, lasting from a few seconds up to several hours. Open time, or else delay in starting to swell (DSS) means that, after the components, including the cellulose ether, have been mixed, a certain further period of time passes before the cellulose ether, if at all possible abruptly, increases the viscosity of the mixture.

The combination of preventing the cellulose ether clumping and of having an open time is as a rule achieved by crosslinking cellulose ethers. In this connection, crosslinking means the linking of at least two different polymer chains by way of bifunctional or polyfunctional molecules, such as dialdehydes, such as glyoxal, glutaraldehyde or structurally related compounds, and also diesters, dicarboxylic acids, dicarboxamides and an hydrides.

Reacting free hydroxyl groups of the cellulose ether with aldehydes, with the formation of hemiacetals, generates a partial, reversible crosslinking, which is cleaved, with a time delay, on dissolving in neutral or weakly acidic water. An abrupt increase in viscosity, without clumping, takes place after the powder has been distributed in the aqueous medium and after a defined open time, which can be regulated, by way of the degree of crosslinking, by the quantity of crosslinking reagent which is added.

CA-C-947 281 describes crosslinking at acid pH using phosphoric acid and dialdehydes, while U.S. Pat. No. 3,372,156 describes crosslinking using dialdehyde sugars. The mechanism of crosslinking with different dialdehydes when crosslinking hydroxypropyl cellulose is described in detail by S. Suto and M. Yoshinaka in Journal of Material Science 28 (1993), pp. 4644 to 4650.

A feature possessed in common by the abovementioned crosslinked cellulose ethers, in particular those which crosslink with hemiacetal formation, is that, in an alkaline medium at pH>9, the crosslinking sometimes opens so rapidly that clumping of the material to be dissolved occurs irrespective of the quantities of crosslinking reagent which are used for the crosslinking reaction. As a result, it is no longer possible to ensure a uniform, rapid development of viscosity at the sought-after point in time. However, if the bonds, by way of which the crosslinking is brought about, are stabilized, for example by reacting with propane dihalide or epihalo-hydrin, the resulting crosslinking is so stable that cleavage into the discrete polymer chains no longer takes place and the crosslinked cellulose ethers in general prove to be insoluble in water.

U.S. Pat. No. 3,461,115 describes the crosslinking of hydroxyethyl cellulose using dicarboxylic acids and the corresponding esters and salts, resulting in products which can be stirred, without agglutination, into water which is at neutral pH. However, the difficulty of achieving such a crosslinking increases as the number of free hydroxyl groups which are available for a crosslinking decreases, i.e. as the degree of alkylation of the cellulose ether increases.

The problem of the chronologically limited stability of the crosslinking under alkaline conditions was partially remedied by developing special methods which can be used for preparing products which exhibit a delay in starting to swell, and can be stirred in without agglutination, even in alkaline media.

These methods include, in particular, the method described in U.S. Pat. No. 1,465,934, in which dialdehydes are combined with boric acid or water-soluble borates, and the combination of glyoxal solutions and potassium dihydrogen phosphate (Kongop Hwahak (1999), 10(4), pp. 581 to 585).

In addition to this, it is also possible to use silicon-containing reagents for crosslinkings which are partially alkali-stable. An example of this is provided by JP 08/183 802, in which alkoxylated and acyloxyalkylated silicon compounds are used.

However, a feature possessed in common by these methods is that they are only partially effective, or not effective at all, in strongly alkaline media, at pH values of >11, as can exist, for example, in building material mixtures, since these crosslinkings, too, are rapidly opened under these conditions.

As described in WO 80/00842, carbodiimides have been used for converting carboxymethyl cellulose in aqueous solution. Gel hydrates of high viscosity are formed by hydrophobizing the acid groups of the carboxymethyl cellulose, by using from 0.5 to 2 equivalents of carbodiimide per acid group of the carboxymethyl cellulose.

It is likewise possible to hydrophobize hydroxyethyl cellulose films by reacting with carbodiimides, dissolved in chlorinated hydrocarbons, while catalyzing with strong mineral acids such as phosphoric acid, hydrochloric acid or tetrafluoroboric acid, and also sodium alkoxide, as described in CS-A-174425.

The alcoholate groups of the hydroxyethyl cellulose are blocked by reaction with the carbodiimides, with the formation of urea derivatives.

The object of the present invention was therefore to develop modified cellulose ethers which are distinguished by properties which are improved from the application technology point of view such that the cellulose ethers can be stirred into water at a pH of ≧11 without agglutination and ensure a certain delay in starting to swell, which delay is in the range of from seconds to hours, even in alkaline medium.

The object is achieved by means of modified cellulose ethers which can be obtained by reacting cellulose ethers having free hydroxyl groups with organic, bifunctional and/or polyfunctional carboxylic acids which have been activated by reaction with nitrogen-containing compounds, and also by a process for preparing these modified cellulose ethers, in which process cellulose ethers having free hydroxyl groups are reacted with organic, bifunctional and/or polyfunctional carboxyiic acids which have been activated by reaction with nitrogen-containing compounds.

In the present invention, carboxylic acids having more than two acid groups per molecule are described as being polyfunctional carboxylic acids.

It has been found, surprisingly, that the modified cellulose ethers can be stirred into aqueous solutions without agglutination and also possess a delay in starting to swell of at least 2 seconds even in an alkaline medium at a pH of ≧11.

The nitrogen-containing reagents are preferably carbodiimide group-containing and/or carbonyldiimidazole group-containing compounds or their salts.

It is also possible to use reagents which possess more than one carbodiimide group or carbonyldiimidazole group per molecule.

The choice of the carbodiimide group-containing and/or carbonyldiimidazole group-containing compounds is in no way restricted.

However, preference is given to using compounds such as dicyclohexyl-carbodiimide or diisopropylcarbodiimide or related, alkyl group-carrying or aryl group-carrying carbodiimides, including those which are asymmetrically substituted, as carbodiimide group-containing compounds.

It is likewise possible to use salts of carbodiimide group-containing compounds, such as N,N′-dicyclohexylcarbodiimide methiodide or N-(3-dimethylaminopropyl)-N′-ethylcarbodiimide hydrochloride or comparable compounds.

The quantity of the nitrogen-containing reagent which is used, based on the cellulose ether, is preferably in the range from 0.01 to 20% by weight. Particular preference is given to using between 0.1 and 5% by weight.

The ratio by weight of the quantity of nitrogen-containing reagent used to the quantity of organic acid used is preferably from 5:95 to 95:5, with this ratio particularly preferably being from 1.5:1 to 5:1.

The quantity of organic carboxylic acid which is used, based on the cellulose ether, is preferably less than 20% by weight, and is particularly preferably in the range from 0.2 to 5% by weight.

Preference is given to using compounds such as maleic acid or its derivatives in which at least one C—H bond is partially or completely replaced with a C—C bond as organic dicarboxylic acids.

Particular preference is given to using polycarboxylic acids such as citric acid or its derivatives in which at least one C—H bond is replaced with a C—C bond.

When citric acid is used, a more or less pronounced state of markedly increased viscosity, which is visible macroscopically as gel formation, is passed through in the course of the process of dissolving in alkaline media.

It is likewise possible to use salts of the corresponding carboxylic acids. The cellulose ethers which are preferably employed are methyl cellulose, ethyl cellulose, carboxymethyl cellulose, hydroxyethyl cellulose and hydroxypropyl cellulose and also their mixed ethers hydroxyethylethyl cellulose, hydroxyethylmethyl cellulose and hydroxypropylmethyl cellulose, and also other conceivable mixed ether, including those with additional substituents.

The crosslinking preferably takes place at temperatures in the range from 0 to 150° C., in each case depending on the boiling point of the organic suspending agent employed, but particularly preferably in the range from 15 to 100° C.

In a preferred embodiment, the commercial quality cellulose ether is suspended in an organic suspending agent, without going into solution, with the water content of the mixture composed of cellulose ether, organic suspending agent and organic acid preferably being less than 20% by weight, based on the quantity of cellulose ether employed.

Particular preference is given to carrying out the process at a total water content of less than 10% by weight, in particular at less than 5% by weight.

Compounds which do not react with carbodiimides or carbonyldiimidazoles, in particular acetone, diethyl ether and ethers having alkyl chains containing up to 8 carbon atoms per chain, as well as cyclic ethers, such as dihydropyran, dihydrofuran, tetrahydrofuran or dioxane, ethylene glycol dimethyl ether, diethylene glycol dimethyl ether, triethylene glycol dimethyl ether, tetraethylene glycol dimethyl ether, straight-chain and branched hydrocarbons having up to 12 carbon atoms, and also cyclic compounds, such as cyclopentane or cyclohexane, or aromatic compounds, such as toluene or benzene or alkyl-substituted toluenes or benzenes, are preferably selected as organic suspending agents.

It is also conceivable to bring essentially dry, pulverulent cellulose ethers into contact, by means of intensive mixing, for example in a customary mixing unit, with a solution comprising a mixture of bifunctional and/or poly-functional organic carboxylic acid and nitrogen-containing reagent in a nonnucleophilic organic solvent.

The above-described reaction of cellulose ethers with bifunctional and/or polyfunctional organic carboxylic acids, which are activated by using nitrogen-containing reagents, such as carbodiimides or carbonyldiimidazoles, leads to cellulose ethers which can even be stirred into alkaline media without clumping before a perceptible development of viscosity sets in after a defined period of delay in starting to swell.

In addition to depending on the nature and quantity of the acid employed, the length of the delay in starting to swell also depends on the carbodiimide or carbonyldiimidazole employed and is considerably influenced by the magnitude of the pH of the solution to be prepared (the length of the delay in starting to swell is inversely proportional to the magnitude of the concentration of alkali). However, depending on the crosslinking conditions which are selected, periods of delay in starting to swell of from a few seconds up to hours can still be achieved even at high pH values of 13 or more. Under given limiting conditions, the quantity of carboxylic acid which is added can also be used to selectively influence the delay in starting to swell.

Any attempt to exclusively react cellulose ethers having a limited number of free primary and, in particular, secondary hydroxyl groups with dicarboxylic and/or polycarboxylic acids under heterogeneous conditions, without any activation of the carboxylic acid(s) with carbodiimides or carbonyldiimidazoles, does not lead, despite high acid concentrations, to products which can be stirred into alkaline media without agglutination or which exhibit a delay in starting to swell.

The same applies to exclusively reacting cellulose ethers with carbodiimides or carbonylimidazoles without adding dicarboxylic and/or polycarboxylic acids.

The process according to the invention is described in more detail below with the aid of implementation examples without, however, being restricted by these examples.

Determining the Viscosity

Viscosities, which are given in mPa s, are determined by using a Hoppler falling-ball viscosimeter to measure, at 20° C., 1.9% aqueous solutions of the corresponding cellulose ether, with reference to the dry solids content and allowing for the present moisture content of the powder.

Determining the Delay in Starting to Swell

The delay in starting to swell is measured at 20° C. using a Brabender viscosimeter, with this measurement being subjected to software-assisted analysis. The data in [BUs], which are obtained in this connection, refer to Brabender viscosity units, which are directly proportional to a corresponding viscosity in mPa s.

The cellulose ethers are reacted, and prepared for a Brabender measurement, in accordance with the following process:

### EXAMPLES 1 TO 17

100 g of cellulose ether (absolutely dry), with the amount weighed out being corrected for a residual moisture content of less than 2%, are suspended in 750 g of dimethoxyethane at from 50 to 70° C.

The appropriate quantity, as specified in the table, of the carbodiimide employed, dissolved in approx. 30 g of organic solvent (dimethoxyethane unless expressly indicated otherwise), is firstly metered in, after which, in that order, the appropriate quantity of acid, where appropriate in dissolved form, is metered in. The mixture is reacted at from 50 to 70° C. for two hours and the resulting suspension is then filtered off with suction, in the hot, on a glass frit and subsequently washed twice with a little acetone. The resulting product is dried at 70° C. and then ground using an Alpine mill fitted with a 180μ strainer basket insert.

The development of viscosity by the product which has been prepared in this way is investigated in a Brabender viscosimeter using software-assisted analysis.

For this, an appropriate quantity of the modified cellulose ether, which quantity depends on the viscosity to be expected, is suspended in water which has been adjusted to different pH values. The measurement is started by adding the cellulose ether and, with a starting viscosity of approx. 35±2 BUs (Brabender units), the time at which the viscosity is greater than twice the starting viscosity (delay in starting to swell, DSS) is determined, as is the time of maximal viscosity development (gel structure) and the time at which the viscosity in practice corresponds to the effective final viscosity.

TABLE 1
Dependence of the delay in starting to swell on the pH at
different citric acid and carbodiimide concentrations

| | | | | | | Max. | Final |
|---|---|---|---|---|---|---|---|
| Ex. | | % by wt. | % by wt. | | DSS⁵⁾ | visc.⁶⁾ | visc.⁷⁾ |
| No. | CE¹⁾ | of DCC²⁾ | of CA³⁾ | pH⁴⁾ | [s] | [s] | [s] |
| 1 | A | 2.5 | 0.5 | 12.5 | 105 | 260 | 740 |
| 2 | A | 2.5 | 0.5 | 13.0 | 50 | 120 | 450 |
| 3 | A | 5.0 | 1.0 | 12.5 | 475 | 1 255 | 2 365 |
| 4 | A | 5.0 | 1.0 | 13.0 | 80 | 190 | 750 |
| 5 | A | 6.0 | 1.2 | 12.5 | 260 | 700 | 1 705 |
| 6 | A | 6.0 | 1.2 | 13.0 | 120 | 290 | 1 330 |

¹⁾Cellulose ether A: hydroxyethylmethyl cellulose, viscosity of the unmodified material, approx. 3 800 mPa s; 26.5% OCH₃, 5% OC₂H₄
²⁾Carbodiimide employed: dicyclohexylcarbodiimide
³⁾Acid employed: citric acid
⁴⁾pH of the aqueous solution into which the modified cellulose ether is stirred
⁵⁾DSS: delay in starting to swell; with a starting viscosity of approx. 35 BUs the time at which the viscosity exceeds twice the starting viscosity
⁶⁾The time at which the development of the viscosity is maximal
⁷⁾The time at which the final viscosity has in practice been reached

TABLE 2
Dependence of the delay in starting to swell on different citric
acid concentrations when using a constant quantity of carbodiimide and at
a pH of 13.0; variation in the viscosity of the unmodified cellulose ethers

| | | | | | | Max. | Final |
|---|---|---|---|---|---|---|---|
| Ex. | | % by wt. of | % by wt. of | | DSS | visc. | visc. |
| No. | CE¹⁾ | DCC | CA | pH | [s] | [s] | [s] |
| 7 | A | 5.0 | 0.5 | 13.0 | 40 | 80 | 320 |
| 4 | A | 5.0 | 1.0 | 13.0 | 80 | 190 | 755 |
| 8 | A | 5.0 | 1.5 | 13.0 | 140 | 460 | 1 130 |
| 9 | B | 5.0 | 0.5 | 13.0 | 80 | 155 | 480 |
| 10 | B | 5.0 | 1.0 | 13.0 | 155 | 335 | 920 |
| 11 | B | 5.0 | 3.0 | 13.0 | 235 | 800 | 1665 |

¹⁾Cellulose ether B: hydroxyethylmethyl cellulose, viscosity of the unmodified material, approx. 100 000 mPa s; 27% OCH₃, 5% OC₂H₄

TABLE 3
Dependence of the delay in starting to swell and of the
progress of the viscosity on the carbodiimide employed

| | | | | % by | | | Max. | Final |
|---|---|---|---|---|---|---|---|---|
| Ex. | | % by wt. | | wt. | | DSS | visc. | visc. |
| No. | CE | of CDI¹⁾ | CDI²⁾ | of CA | pH | [s] | [s] | [s] |
| 12 | B | 1.53 | a | 1.0 | 13.0 | 170 | 325 | 1 010 |
| 13 | B | 4.21 | b | 1.0 | 13.0 | 60 | 295 | 1 285 |
| 14 | B | 2.32 | c | 1.0 | 13.0 | 90 | 500 | 1 840 |
| 15 | B | 5.13 | d | 1.0 | 13.0 | 130 | 265 | 490 |

¹⁾Percent by weight of the carbodiimide employed, based on the dry weight of the cellulose ether, calculated on a quantity of carbodiimide employed of 0.0121 mol
²⁾Carbodiimide employed:
a diisopropylcarbodiimide
b N,N′-dicyclohexylcarbodiimide methiodide, dissolved in dimethoxyethane/acetone 4:1
c N-(3-dimethylaminopropyl)-N′-ethylcarbodiimide hydrochloride, dissolved in dichloromethane
d 1-cyclohexyl-3-(2-morpholinoethyl)carbodiimide metho-p-toluenesulfonate, dissolved in acetone/dichloromethane 1:1

TABLE 4
Delay in starting to swell when using maleic acid

| | | | | | | | Max. |
|---|---|---|---|---|---|---|---|
| Ex. | | % by wt. of | Acid | % by wt. | | DSS | visc. |
| No. | CE | DCC¹⁾ | employed | of acid | pH | [s] | [s] |
| 16 | B | 2.5 | maleic acid | 0.96 | 13.0 | 20 | 200 |

¹⁾Carbodiimide employed: dicyclohexylcarbodiimide

TABLE 5
Delay in starting to swell when using an hydroxypropylmethyl
cellulose

| Ex. | | % by wt. of | % by wt. of | | DSS | Max. visc. |
|---|---|---|---|---|---|---|
| No. | CE¹⁾ | DCC | CA | pH | [s] | [s] |
| 17 | C | 2.5 | 1.0 | 13.0 | 215 | 475 |

¹⁾Cellulose ether C: hydroxypropylmethyl cellulose, viscosity of the unmodified material, approx. 10 000 mPa s; 29% OCH₃, 5% OC₃H₆

### EXAMPLE 18

100 g of cellulose ether (absolutely dry), with the amount weighed out being corrected for a residual moisture content of less than 2%, are suspended, at room temperature (from 18 to 25° C.), in 750 g of dimethoxyethane. 2.5 g of dicyclohexylcarbodiimide, dissolved in approx. 30 g of organic solvent, are firstly metered in, after which, and in that order, 1.0 g of citric acid, which is likewise in dissolved form in organic solvent, is metered in. The mixture is stirred at room temperature for two hours and the resulting suspension is then filtered off with suction and subsequently washed twice with a little acetone. The modified product is dried at 70° C. and then ground using an Alpine mill fitted with a 180μ strainer basket insert.

The ground product is tested for its delay in starting to swell in alkaline medium using the Brabender viscosimeter, as described above (Table 6).

### EXAMPLE 19

The procedure is analogous to that described in Example 18 apart from the fact that the modified product is not dried at 70° C. but is instead dried at room temperature (from 18 to 25° C.) by simply being left to stand (Table 6).

TABLE 6
Conversion to modified cellulose ethers at room temperature
(from 18 to 25° C.)

| Ex. | | % by wt. of | % by wt. of | | DSS | Max. visc. |
|---|---|---|---|---|---|---|
| No. | CE | DCC | CA | PH | [s] | [s] |
| 18 | B | 2.5 | 1.0 | 13.0 | 55 | 180 |
| 19 | B | 2.5 | 1.0 | 13.0 | 65 | 350 |

### EXAMPLE 20

100 g of cellulose ether (absolutely dry), with the amount weighed out having been corrected for a residual moisture content of less than 2%, are suspended, at room temperature (70° C.), in 750 g of dimethoxyethane. 1.96 g (0.0121 mol) of carbonyldiimidazole, in approx. 30 g of dimethoxyethane, are first of all metered in, after which, and in that order, 1.0 g of citric acid, in dissolved form in organic solvent, is metered in. The mixture is stirred at 70° C. for two hours and the resulting suspension is then filtered off with suction and subsequently washed twice with a little acetone. The modified product is dried at 70° C. and then ground using an Alpine mill fitted with a 180μ strainer basket insert.

The ground product is tested for its delay in starting to swell in alkaline medium using the Brabender viscosimeter as described above (Table 7).

TABLE 7
Conversion to modified cellulose ethers using carbonyldiimidazole

| Ex. | | % by wt. of | % by wt. of | | DSS | Max. visc. |
|---|---|---|---|---|---|---|
| No. | CE | CDI | CA | pH | [s] | [s] |
| 20 | B | 2.5 | 1.0 | 13.0 | 235 | 435 |

### EXAMPLE 21

100 g of cellulose ether (absolutely dry), with the amount weighed out having been corrected for a residual moisture content of less than 2%, are intimately mixed in a kneading unit, at room temperature for 15 minutes, with a mixture composed of 1.53 g of diisopropylcarbodiimide and 1.0 g of citric acid in approx. 30 g of dimethoxyethane. In order to prepare this mixture, the individual components are in each case dissolved in 15 g of dimethoxyethane and mixed together, and heated to approx. 35° C., directly before being added to the cellulose ether.

The modified product is heated at 70° C. for 2 hours and then ground using an Alpine mill fitted with a 180μ strainer basket insert.

The ground product is tested for its delay in starting to swell in alkaline medium using the Brabender viscosimeter as described above (Table 8).

TABLE 8
Conversion to modified cellulose ethers using an essentially
dry cellulose ether powder (residual moisture content <2%)

| Ex. | | % by wt. of | % by wt. of | | DSS | Max. visc. |
|---|---|---|---|---|---|---|
| No. | CE | CDI¹⁾ | CA | pH | [s] | [s] |
| 21 | B | 1.53 | 1.0 | 13.0 | 185 | >3 500²⁾ |

¹⁾Carbodiimide employed: diisopropylcarbodiimide
²⁾Very slow development of viscosity; the maximum viscosity is still not completely reached after 3 500 seconds

### COMPARATIVE EXAMPLE 1

The procedure is as described for Examples 1 to 17 apart from the fact that only 1.0 g of citric acid, dissolved in 30 g of dimethoxyethane, is metered in; that is, no nitrogen-containing reagent is added.

### COMPARATIVE EXAMPLE 2

The procedure is as described for Examples 1 to 17 apart from the fact that only 5.0 g of dicyclohexylcarbodiimide, in 30 g of dimethoxyethane, are metered in.

TABLE 9
Delay in starting to swell when using only one component
(dicarboxylic/polycarboxylic acid or carbodiimide)

| Comparative | | | | | | |
|---|---|---|---|---|---|---|
| Example | | % by wt. | % by wt. | | DSS | Final visc. |
| No. | CE | of DCC | of CA | pH | [s] | [s] |
| 1 | B | — | 1.0 | 13 | —¹⁾ | — |
| 2 | B | 5.0 | — | 13 | —¹⁾ | — |

¹⁾Immediate clumping

1. A modified cellulose ether obtained by reacting cellulose ethers having free hydroxyl groups with an organic, bifunctional and/or polyfunctional carboxylic acid which has been activated by reaction with a nitrogen-containing compound.

2. A process for preparing modified cellulose ethers which comprises reacting cellulose ethers having free hydroxyl groups with an organic, bifunctional and/or polyfunctional carboxylic acid which have been activated by reaction with a nitrogen-containing compound.

3. The process as claimed in claim 2, wherein the nitrogen-containing compound is a carbodiimide group-containing and/or a carbonyldiimidazole group-containing compound or a salt thereof.

4. The process as claimed in claim 2, wherein the nitrogen-containing compound employed, based on the cellulose ether, ranges from 0.01 to 20% by weight.

5. The process as claimed in claim 2, wherein a ratio by weight of the nitrogen-containing compound to of said organic bifunctional and/or polyfunctional carboxylic acid ranges from 5:95 to 95:5.

6. The process as claimed in claim 2, wherein said organic bifunctional and/or polyfunctional carboxylic acid, based on the cellulose ether, is less than 20% by weight.

7. The process as claimed in claim 2, wherein the organic bifunctional and/or polyfunctional carboxylic acid employed is maleic acid or a derivative thereof in which at least one C—H bond is replaced with a C—C bond.

8. The process as claimed in claim 2, wherein the organic bifunctional and/or polyfunctional carboxylic acid employed is citric acid or a derivative thereof in which at least one C—H bond is replaced with a C—C bond.

9. The process as claimed in claim 2, wherein the cellulose ether is selected from the group consisting of methyl cellulose, ethyl cellulose, carboxymethyl cellulose, hydroxyethyl cellulose, hydroxypropyl cellulose, hydroxylethylethyl cellulose, hydroxyethylmethyl cellulose, hydroxypropylmethyl cellulose, and mixtures thereof.

10. The process as claimed in claim 2, wherein the reacting step takes place at a temperature ranging from 0 to 150° C.

11. The process as claimed in claim 2, wherein the reacting step takes place in an organic suspending agent and water.

12. The process as claimed in claim 11, wherein the water comprises less than 20% by weight, based on the cellulose ether.

13. The process as claimed in claim 2, further comprising mixing essentially dry, pulverulent cellulose ether with the organic bifunctional and/or polyfunctional carboxylic acid and the nitrogen-containing compound in a non-nucleophilic organic solvent to provide a preliminary mixture and intensively mixing the preliminary mixture prior to said reacting step.
